(19) United States
(12) Patent Application Publication
(10) Pub. No.: US 2026/0289794 A1
(43) Pub. Date: Sep. 24, 2026

(54) COMPUTER-IMPLEMENTED METHOD, USER INPUT SYSTEM, AND COMPUTER-PROGRAM PRODUCT

(71) Applicant: BOE Technology Group Co., Ltd., Beijing (CN)

(72) Inventor: Jingru Wang, Beijing (CN)

(73) Assignee: BOE Technology Group Co., Ltd., Beijing (CN)

(21) Appl. No.: 18/996,042

(22) PCT Filed: Mar. 17, 2023
(86) PCT No.: PCT/CN2023/082075

§ 371 Date: Jan. 17, 2025

(51) Int. Cl. G06T 7/20; G06F 3/01; G06V 40/20

(52) U.S. Cl. CPC G06T 7/20; G06F 3/013; G06F 3/017; G06V 40/28; G06T 2207/30241; G06V 2201/07

(57) ABSTRACT

A computer-implemented method is provided. The computer-implemented method includes determining a reference surface; determining a target object of a target user; determining a relative displacement between the target object and the reference surface; and determining a user-machine interactive instruction based on the relative displacement.

### TECHNICAL FIELD

The present invention relates to display technology, more particularly, to a computer-implemented method, a user input system, and a computer-program product.

### BACKGROUND

A display apparatus typically includes a display panel for displaying an image. Sometimes the display apparatus also includes a touch device such as a touch control layer on the display panel. The touch device allows a user to input information by touch writing.

### SUMMARY

In one aspect, the present disclosure provides a computer-implemented method, comprising determining a reference surface; determining a target object of a target user; determining a relative displacement between the target object and the reference surface; and determining a user-machine interactive instruction based on the relative displacement.

Optionally, determining the reference surface comprises determining coordinates of a plurality of calibration points in a three-dimensional coordinate system; and deriving the reference surface based on the plurality of calibration points.

Optionally, determining the coordinates of the plurality of calibration points in the three-dimensional coordinate system comprises capturing an image of a real-world object using a camera; and converting coordinates of the plurality of calibration points in the image of the real-world object in an image coordinate system into the coordinates of the plurality of calibration points in the three-dimensional coordinate system based on parameters of the camera.

Optionally, the user-machine interactive instruction comprises displaying a trajectory image; wherein the computer-implemented method further comprises detecting and tracking an object motion trajectory of the target object relative to the reference surface; and displaying the trajectory image in a target area based on the object motion trajectory relative to the reference surface.

Optionally, the computer-implemented method further comprises determining whether the object motion trajectory transitions into a pausing gesture; and upon determination the object motion trajectory transitions into a pausing gesture, pausing displaying the trajectory image.

Optionally, the computer-implemented method further comprises converting, in real time, the object motion trajectory relative to the reference surface into the trajectory image; pausing convening the object motion trajectory relative to the reference surface into the trajectory image upon detecting a pausing gesture; and continuing detecting and tracking the object motion trajectory of the target object relative to the reference surface subsequent to pausing converting the object motion trajectory relative to the reference surface into the trajectory image.

Optionally, the computer-implemented method further comprises resuming converting, in real time, the object motion trajectory relative to the reference surface into a new trajectory image at a new reference point at which the new trajectory image starts relative to a previous trajectory image; wherein the new reference point is determined based on a result of continuing detecting and tracking the object motion trajectory relative to the reference surface.

Optionally, the pausing gesture is a gesture in which the target object moves toward a pausing direction relative to the reference surface; and a gesture is recognized as the pausing gesture if the object making the object motion trajectory moves along the pausing direction relative to the reference surface by a distance exceeding a second threshold distance.

Optionally, the computer-implemented method further comprises determining whether the object motion trajectory transitions into a displaying gesture; and upon determination the object motion trajectory transitions into a displaying gesture, displaying the trajectory image in a target area based on the object motion trajectory relative to the reference surface.

Optionally, the displaying gesture is a gesture contacting a finger of the target user with the reference surface.

Optionally, the computer-implemented method further comprises recognizing an initiation gesture indicating an initiation of providing the user-machine interactive instruction; wherein providing the user-machine interactive instruction is performed subsequent to recognizing the initiation gesture.

Optionally, the user-machine interactive instruction comprises executing a user command; wherein the computer-implemented method further comprises detecting and tracking the object motion trajectory of the target object relative to the reference surface; and executing the user command based on the object motion trajectory relative to the reference surface.

Optionally, the user-machine interactive instruction comprises adjusting a reference point; wherein adjusting the reference point comprises recognizing an adjusting gesture of the target user.

Optionally, the adjusting gesture is a gesture having the target object of the target user not in contact with the reference surface, and moving along an adjusting direction; wherein the computer-implemented method further comprises adjusting the reference point along the adjusting direction of a movement of the target object; wherein the gesture is recognized as the adjusting gesture when the movement of the target object is within a distance with respect to the reference surface less than a first threshold distance.

Optionally, the reference point is a point at which displaying a trajectory image starts.

Optionally, the computer-implemented method further comprises determining a target area on the display panel designated for the target user to provide the user-machine interactive instruction.

Optionally, the user-machine interactive instruction comprises displaying a trajectory image in the target area; wherein determining the target area comprises determining a gaze point on the display panel; and determining the target area using the gaze point.

Optionally, determining the gaze point comprises determining whether K number of gaze points of the target user respectively determined from K number of frames of image of the target user are located in a substantially same position.

Optionally, determining the target area comprises determining coordinates of a plurality of calibration points in a three-dimensional coordinate system; establishing a spatial equation of a real-world object based on the coordinates of the plurality of calibration points in the three-dimensional coordinate system; determining a position coordinate of the target object in the three-dimensional coordinate system; and mapping the position coordinate of the target object in the three-dimensional coordinate system onto an input position coordinate in a display panel coordinate system, thereby determining the target area.

Optionally, the display panel is virtually divided into a plurality of candidate target areas; wherein the computer-implemented method further comprises designating at least one candidate target area of the plurality of candidate target areas as the target area for the target user.

Optionally, the computer-implemented method further comprises activating the target area; wherein activating the target area comprises recognizing a respective selection gesture that matches with one of a plurality of candidate selection gestures; and activating a respective candidate target area from the plurality of candidate target areas to be designated as the target area for the target user.

Optionally, the user-machine interactive instruction further comprises adjusting the target area to obtain an adjusted target area.

Optionally, the target object comprises a palm of the target user; adjusting the target area comprises recognizing a gesture of adjusting a position of the palm of the target user.

Optionally, the computer-implemented method further comprises determining whether the adjusted target area overlaps with any of activated target areas in the display panel.

Optionally, the computer-implemented method further comprises, upon determination the adjusted target area overlaps with any of activated target areas in the display panel, providing a notification to the target user that the adjusted target area overlaps with any of activated target areas in a display panel.

Optionally, the computer-implemented method further comprises, upon determination the adjusted target area does not overlap with any of activated target areas in the display panel, replacing the target area with the adjusted target area for inputting information or providing user command.

Optionally, the computer-implemented method further comprises recognizing a confirming gesture of the target user; and upon recognizing the confirming gesture, accepting the adjusted target area as a confirmed area for inputting information or providing user command when the target area is subject to adjustment, or accepting the target area as the confirmed area for inputting information or providing user command when the target area is not subject to adjustment.

Optionally, identifying the target user comprises detecting and tracking a gesture of the user; and comparing the gesture of the user with a target gesture; wherein, upon determination that the gesture of the user is the target gesture, the user is identified as the target user.

In another aspect, the present disclosure provides a user input system, comprising one or more cameras; a display panel; a memory; and one or more processors; wherein the memory and the one or more processors are connected with each other; and the memory stores computer-executable instructions for controlling the one or more processors to determine a reference surface; determine a target object of a target user; determine a relative displacement between the target object and the reference surface; and determine a user-machine interactive instruction based on the relative displacement.

In another aspect, the present disclosure provides a computer-program product, comprising a non-transitory tangible computer-readable medium having computer-readable instructions thereon, the computer-readable instructions being executable by a processor to cause the processor to perform determining a reference surface; determining a target object of a target user; determining a relative displacement between the target object and the reference surface; and determining a user-machine interactive instruction based on the relative displacement.

### BRIEF DESCRIPTION OF THE FIGURES

The following drawings are merely examples for illustrative purposes according to various disclosed embodiments and are not intended to limit the scope of the present invention.

FIG. 1 is a flow chart illustrating a computer-implemented method in some embodiments according to the present disclosure.

FIG. 2 depicts a top view image of a hand of a user.

FIG. 3 depicts a side view image of a hand of a user.

FIG. 4 is a flow chart illustrating a computer-implemented method in some embodiments according to the present disclosure.

FIG. 5 shows a bounding box of a hand of the target user in a respective image of images of the hand of the target user.

FIG. 6 is a flow chart illustrating a computer-implemented method in some embodiments according to the present disclosure.

FIG. 7 illustrates a process of obtaining internal parameters and external parameters of a camera.

FIG. 8 illustrates a plurality of candidate selection gestures in some embodiments according to the present disclosure.

FIG. 9 is a flow chart illustrating a computer-implemented method in some embodiments according to the present disclosure.

FIG. 10 is a flow chart illustrating a computer-implemented method in some embodiments according to the present disclosure.

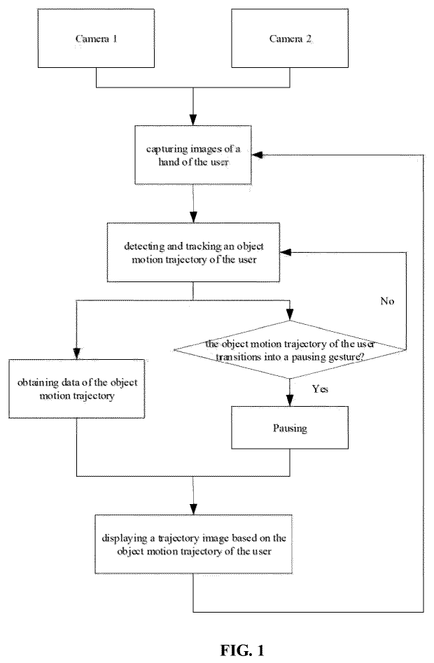

FIG. 1I is a flow chart illustrating a computer-implemented method in some embodiments according to the present disclosure.

FIG. 12 is a schematic diagram illustrating a user input system in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Related input methods typically require a touch panel or a laser pen for inputting information. The inventors of the present disclosure discover that the related input methods are often not suitable for certain scenarios, particularly a scenario where multiple users share a same display panel for displaying the user input. For example, each of the multiple users will have to approach the same display panel when they desire to write on the display panel.

Accordingly, the present disclosure provides, inter alia, a computer-implemented method, a user input system, and a computer-program product that substantially obviate one or more of the problems due to limitations and disadvantages of the related art. In one aspect, the present disclosure provides a computer-implemented method. In some embodiments, the computer-implemented method includes determining a reference surface; determining a target object of a target user; determining a relative displacement between the target object and the reference surface; and determining a user-machine interactive instruction based on the relative displacement.

In some embodiments, the computer-implemented method includes identifying a target user, the target user being a user who intends to remotely input information or provide a user command on a display panel. Various appropriate methods may be used for identifying the target user. In some embodiments, identifying the target user includes recognizing a target gesture of a user. Examples of target gestures include raising a hand, holding a palm on a table for over a period of time.

In some embodiments, the computer-implemented method includes determining a target area on the display panel designated for the target user to input information or provide the user command. Various appropriate methods may be used for determining the target area. In some embodiments, determining the target area includes determining a gaze point on the display panel; and determining the target area using the gaze point. Optionally, the computer-implemented method includes determining a gaze direction of the target user, and determining a point on the display panel where the gaze direction intersects with a plane of the display panel, thereby determining the gaze point. Optionally, the computer-implemented method includes determining the gaze point using a neural network.

In some embodiments, the gaze point may be used as a reference point. For example, the target area may be an area having the gaze point as a central point.

In some embodiments, the gaze point may be used as a reference point. In one example, the reference point is a point at which displaying of the information inputted by the target user or the user command inputted by the target user starts. Optionally, the reference point is a point at which displaying a trajectory image starts. Optionally, the reference point is a point at which displaying a stoke of a character (e.g., a Chinese character) or a letter (e.g., a, b, c, d) starts.

In some embodiments, the computer-implemented method further includes adjusting the reference point. Optionally, adjusting the reference point includes recognizing an adjusting gesture of the target user. In one example, the adjusting gesture is a gesture having a target object (e.g., a finger) of the target user not in contact with a surface of a desk, and moving along an adjusting direction. Optionally, the computer-implemented method further includes adjusting the reference point along the adjusting direction of a movement of the target object (e.g., a finger movement). Optionally, the gesture is recognized as the adjusting gesture when the movement of the target object (e.g., the finger movement) is within a distance with respect to the reference surface less than a first threshold distance. Various appropriate threshold distances may be used as the first threshold distance, for example, 1 mm, 2 mm, 3 mm, 4 mm, 5 mm, 6 mm, 7 mm, 8 mm, 9 mm, or 10 mm.

In some embodiments, the computer-implemented method further includes recognizing an initiation gesture indicating an initiation of inputting information or providing the user command. Upon recognizing the initiation gesture, the user is allowed to input information or provide the user command on the display panel. Examples of initiation gestures include a L-shape gesture.

Various appropriate initiation gestures may be used for various appropriate purposes. In some embodiments, the initiation gesture is an initiation gesture of a first type indicating an initiation of displaying a trajectory image based on an object motion trajectory of the user. For example, subsequent to recognizing an initiation gesture of the first type, the computer-implemented method further includes determining whether the object motion trajectory of the user transitions into a displaying gesture; and upon determination the object motion trajectory of the user transitions into a displaying gesture, displaying the trajectory image in a target area based on the object motion trajectory of the user relative to the reference surface. In one example, displaying the trajectory image includes displaying a stroke of a character or a letter based on the object motion trajectory.

In some embodiments, the initiation gesture is an initiation gesture of a second type indicating an initiation of providing the user-machine interactive instruction. For example, subsequent to recognizing an initiation gesture of the second type, the computer-implemented method further includes determining whether the object motion trajectory of the user transitions into a page-turning gesture; and upon determination the object motion trajectory of the user transitions into a page-turning gesture, changing an image displayed on the display panel to a different image (e.g., a next page).

In some embodiments, the computer-implemented method further includes displaying a trajectory image in the target area based on an object motion trajectory of the user relative to the reference surface, for example, a finger motion trajectory on the desk. Optionally, displaying the trajectory image is performed subsequent to recognizing the initiation gesture. Optionally, displaying the trajectory image is performed subsequent to determining the target area. The object motion trajectory of the user may be a motion trajectory of any appropriate object, for example, the user's finger (e.g., the user's index finger) or any appropriate object hold by the user such as a stylus, a pen, a pencil, or a laser pen.

In some embodiments, the computer-implemented method further includes executing a user command based on the object motion trajectory of the user relative to the reference surface, for example, the finger motion trajectory on the desk. Optionally, executing the user command is performed subsequent to recognizing the initiation gesture. Optionally, executing the user command is performed subsequent to determining the target area.

In some embodiments, the computer-implemented method further includes obtaining images of a hand of the user at one or more different angles. Optionally, images of the hand of the user at one or more different angles include top view images of the hand of the user and side view images of the hand of the user. The term top view generally means a view along a substantially vertical direction, for example, a direction substantially perpendicular to a surface of a desk on which the hand is placed. The term side view generally means a view along a substantially horizontal direction, for example, a direction substantially parallel to a surface of a desk on which the hand is placed. As used herein, the term “substantially vertical,” “substantially horizontal,” “substantially perpendicular,” and “substantially parallel” are not limited to situations of “completely vertical,” “completely horizontal,” “completely perpendicular,” and “completely parallel,” but allow certain degrees of deviation from completely. For example, the deviation may be a deviation of less than 40 degrees, e.g., less than 35 degrees, less than 30 degrees, less than 25 degrees, less than 20 degrees, less than 15 degrees, less than 10 degrees, less than 5 degrees, less than 1 degree, or less than 0.5 degree.

FIG. 1 is a flow chart illustrating a computer-implemented method in some embodiments according to the present disclosure. Referring to FIG. 1, the computer-implemented method in some embodiments includes capturing images of a hand of the user using one or more cameras (e.g., Camera 1 and Camera 2 in FIG. 1). In some embodiments, the one or more cameras include a first camera Camera 1 and a second camera Camera 2 as depicted in FIG. 1. In some embodiments, the first camera Camera 1 and the second camera Camera 2 are configured to capture images of the hand of the user at two different angles. In one example, the first camera Camera 1 is configured to capture side view images of the hand of the user. In another example, the second camera Camera 2 is configured to capture top view images of the hand of the user.

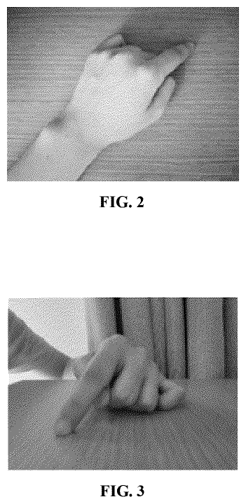

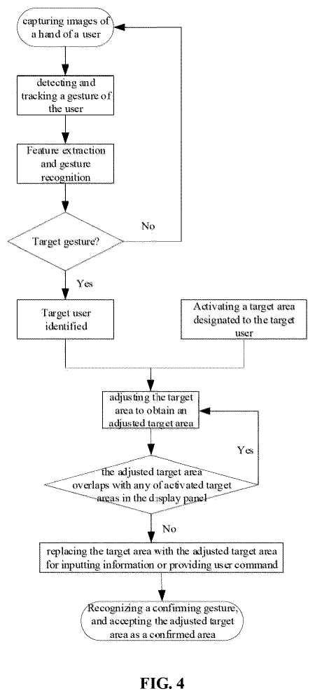

FIG. 2 depicts a top view image of a hand of a user. FIG. 3 depicts a side view image of a hand of a user. In some embodiments, each user or each group of one or more users is assigned with a respective group of cameras including the first camera Camera 1 and the second camera Camera 2. The present computer-implemented method may be used in various appropriate scenarios. In one exemplary scenario, the present computer-implemented method is implemented in a conference room setting, in which a plurality of users or a plurality of groups of users occupy a conference room. The conference room is equipped with one or more groups of the first camera Camera 1 and the second camera Camera 2. For example, each seat in the conference room is equipped with a respective group of the first camera Camera 1 and the second camera Camera 2. In an alternative scenario, at least one user may participate in a conference remotely, for example, the at least one user may join a virtual conference from their home office. The home office may be equipped with the respective group of the first camera Camera 1 and the second camera Camera 2. Various alternative implementations may be practiced in the present disclosure.

In some embodiments, the computer-implemented method further includes detecting and tracking an object motion trajectory of the user, and obtaining data of the object motion trajectory relative to the reference surface. In some embodiments, the computer-implemented method further includes displaying a trajectory image in the target area based on the object motion trajectory of the user relative to the reference surface, for example, finger motion trajectory on the desk. The object motion trajectory of the user may be a motion trajectory of any appropriate object, for example, the user's finger (e.g., the user's index finger) or any appropriate object hold by the user such as a stylus, a pen, a pencil, or a laser pen.

In some embodiments, displaying the trajectory image in the target area based on the object motion trajectory of the user relative to the reference surface includes determining a relative displacement between the target object and the reference surface on a plane parallel to the reference surface; and converting the relative displacement on the plane parallel to the reference surface into the trajectory image.

In some embodiments, the computer-implemented method further includes determining whether the object motion trajectory of the user transitions into a pausing gesture. In some embodiments, the pausing gesture is a gesture in which the target object (e.g., the finger) moves toward a pausing direction relative to the reference surface. In one example, the pausing direction is an upward vertical direction. Optionally, a gesture is recognized as the pausing gesture if the object making the object motion trajectory of the user moves along the upward vertical direction by a distance exceeding a second threshold distance.

Upon determination that the pausing gesture is not detected, the computer-implemented method includes continuing detecting and tracking the object motion trajectory of the user; and obtaining data of the object motion trajectory. For example, the object continues making a motion of a stroke of a character or a letter or a diagram.

Upon determination the object motion trajectory of the user transitions into a pausing gesture, the computer-implemented method includes pausing detecting and tracking the object motion trajectory of the user; pausing obtaining data of the object motion trajectory. In one example, pausing is performed when the user completes a motion of a stroke of a character or a letter or a diagram.

In some embodiments, subsequent to pausing converting the object motion trajectory relative to the reference surface into the trajectory image, the computer-implemented method includes continuing detecting and tracking the object motion trajectory relative to the reference surface. When a pausing gesture is not detected, the computer-implemented method includes converting, in real time, the object motion trajectory relative to the reference surface into the trajectory image. When a pausing gesture is detected, the computer-implemented method includes pausing converting the object motion trajectory relative to the reference surface into the trajectory image. Although converting the object motion trajectory relative to the reference surface into the trajectory image is discontinued, the computer-implemented method continues detecting and tracking the object motion trajectory relative to the reference surface. By continuing detecting and tracking the object motion trajectory relative to the reference surface, once a displaying gesture is detected, the computer-implemented method resumes converting, in real time, the object motion trajectory relative to the reference surface into the trajectory image. When converting, in real time, the object motion trajectory relative to the reference surface into the trajectory image is resumed, a reference point at which displaying the trajectory image starts is required. The inventors of the present disclosure discover that, by continuing detecting and tracking the object motion trajectory relative to the reference surface while the converting, in real time, the object motion trajectory relative to the reference surface into the trajectory image is paused, a new trajectory image (e.g., a trajectory image of a new stroke of a character or a letter) can be accurately displayed at an appropriate position relative to a previous trajectory image (e.g., a trajectory image of a previous stroke of a character or a letter).

The process described above can be repeated until all strokes are complete. The combination of trajectory images of all strokes results in a combined image of a character or a letter, a sentence, or a paragraph, etc. in which all strokes are arranged in appropriate positions. An image of a legible text can be obtained.

In some embodiments, the computer-implemented method in some embodiments includes capturing images of the hand of the user using the first camera Camera 1 and the second camera Camera 2; detecting and tracking an object motion trajectory of the user, and obtaining data of the object motion trajectory. In one example, in a previous frame of image, the data of the object motion trajectory includes a first series F1 of positions of a finger tip of the user; in a present frame of image, the data of the object motion trajectory includes a second series F2 of positions of the finger tip of the user. The finger tip of the user in the second frame of image has a y-axis coordinate of y1 at a time point t1, a y-axis coordinate of y2 at a time point t2, a y-axis coordinate of y3 at a time point t3, and a y-axis coordinate of y4 at a time point t4. The time points t1, t2. t3, and t4 are sequential time points, wherein t1 is a time point earlier than t4. When y1 is greater than each of y2, y3, and y4 by a difference greater than a second threshold distance θ, a pausing gesture is identified. Various appropriate threshold distances may be used as the second threshold distance θ, for example, 1 mm, 2 mm, 3 mm, 4 mm, 5 mm, 6 mm, 7 mm, 8 mm, 9 mm, or 10 mm. In another example, θ is 5 mm.

In some embodiments, the computer-implemented method further includes displaying a trajectory image based on the object motion trajectory of the user relative to the reference surface. In one example, the pausing gesture is recognized in the second frame of image, and the computer-implemented method further includes inputting the first series F1 of positions of the finger tip of the user into a pre-trained neural network (e.g., a recurrent neural network) to recognize the information (e.g., a stroke of a character, a stroke of a letter, a stroke of a diagram, etc.) input by the user; and displaying it as the trajectory image.

In some embodiments, the computer-implemented method further includes recognizing a line changing gesture. Upon recognizing the line changing gesture, the computer-implemented method further includes starting a new line for inputting information or providing user command. In one example, the line changing gesture is a fist gesture.

In some embodiments, the one or more cameras are rotatable cameras, for example, four-directional rotatable cameras (e.g., upward, downward, leftward, rightward). Optionally, the one or more cameras are zoomable cameras, e.g., cameras having adjustable focal lengths. By having these features, gesture recognition and object motion trajectory detection can be performed with an enhanced accuracy.

FIG. 4 is a flow chart illustrating a computer-implemented method in some embodiments according to the present disclosure. Referring to FIG. 4, the computer-implemented method in some embodiments includes capturing images of a hand of a user. For example, the images of the hand of the user may be captured using the first camera Camera 1 depicted in FIG. 1. Once the images of the hand of the user is obtained, the computer-implemented method in some embodiments further includes detecting and tracking a gesture of the user. In some embodiments, detecting and tracking the gesture of the user includes recognizing a hand portion image from a respective image of the images of the hand of the user; extracting a plurality of features from the hand portion image; and recognizing a gesture based on the plurality of features extracted from the hand portion image. In one example, the plurality of features includes 21 features important for recognizing a hand gesture.

As discussed above, the computer-implemented method in some embodiments includes identifying a target user, the target user being a user who intends to remotely input information or provide a user command on a display panel. In some embodiments, identifying the target user includes recognizing a target gesture of a user. Accordingly, subsequent to recognizing the gesture based on the plurality of features extracted from the hand portion image, the computer-implemented method in some embodiments further includes comparing the gesture with the target gesture. Upon determination that the gesture is the target gesture, the user is identified as the target user. Examples of target gestures include raising a hand, holding a palm on a table for over a period of time. In one particular example, the target gesture is holding a palm on a table for over 1 second. The target user's hand motion controls at least a portion of the display panel, for example, the target user is able to remotely input information or provide a user command on the display panel, whereas a non-target user is not capable of doing the same.

As discussed above, the computer-implemented method in some embodiments includes determining a target area on the display panel designated for the target user to input information or provide the user command. In one example, the display panel may be virtually divided into a plurality of candidate target areas, each of which is designated to a respective candidate target user. The display panel is configured to allow the plurality of candidate target users to input information or provide user command in the plurality of candidate target areas simultaneously. In one example, the display panel is virtually divided into eight candidate target areas designated to eight candidate target users. Thus, the display panel allows a total of eight candidate target users to input information or provide user command in a total of eight candidate target areas simultaneously.

In some embodiments, when the target user is identified, the target area is designated to the target user. Referring to FIG. 4, the computer-implemented method in some embodiments further includes activating the target area, for example, displaying the target area on the display panel with a boundary, e.g., of dotted lines. An initial point for input information in the target area may be assigned by the display panel, for example, at an upper left corner of the target area. In one example, the initial point in a coordinate system of the target area has a coordinate (10, 10).

Once the target area is designated to the target user, the computer-implemented method in some embodiments further includes adjusting the target area to obtain an adjusted target area. Optionally, the target object includes a palm of the target user, and adjusting the target area includes adjusting a position of the palm of the user. To illustrate, in one example, the respective image of the images of the hand of the user has a size W1*H1, a display area of the display panel has a size W2*H2. In two adjacent respective images of the images of the hand of the user, a center of a palm portion image in a first adjacent respective image of the images of the hand of the user moves relative to a second adjacent respective image of the images of the hand of the user along an x-axis in a coordinate system of the images of the hand of the user by a distance Dx, and along a y-axis in the coordinate system of the images of the hand of the user by a distance Dy. When the movement of the center of the palm portion image is mapped to the display area of the display panel, the adjusted target area is moved relative to the target area along an x-axis in a coordinate system of the display area of the display panel by a distance (Dx*W2)/W1, and along a y-axis in the coordinate system of the display area of the display panel by a distance (Dy*H2)/H1.

In some embodiments, the computer-implemented method further includes determining whether the adjusted target area overlaps with any of activated target areas in the display panel. Upon determination the adjusted target area overlaps with any of activated target areas in the display panel, the adjusted target area is not adopted for inputting information or providing user command. Optionally, the computer-implemented method further includes providing a notification to the user that the adjusted target area overlaps with any of activated target areas in the display panel. Optionally, the computer-implemented method further includes reiterating the step of adjusting the target area until an updated adjusted target area is identified that does not overlap with any of activated target areas in the display panel.

Upon determination the adjusted target area does not overlap with any of activated target areas in the display panel, the computer-implemented method further includes replacing the target area with the adjusted target area for inputting information or providing user command.

In some embodiments, the computer-implemented method further includes recognizing a confirming gesture of the user. Upon recognizing the confirming gesture, the computer-implemented method includes accepting the adjusted target area as a confirmed area for inputting information or providing user command when the target area is subject to adjustment, or accepting the target area as the confirmed area for inputting information or providing user command when the target area is not subject to adjustment. In one example, the confirming gesture is a fist gesture.

Various appropriate alternative implementations may be practiced in the present disclosure. For example, various alternative methods may be used for determining a target area on the display panel designated for the target user to input information or provide the user command. In some embodiments, the display panel is configured to allow the plurality of candidate target users to input information or provide user command in the plurality of candidate target areas. In one example, the display panel is virtually divided into four candidate target areas designated to four candidate target users. For example, the display panel may have four candidate input positions (e.g., four candidate cursor positions), including [0.25×W_{screen}, 0.25×H_{screen}], [0.25×W_{screen}, 0.75×H_{screen}], [0.75×W_{screen}, 0.25×H_{screen}], and [0.75×W_{screen}, 0.75×H_{screen}]; wherein W_{screen} stands for a width of a display area of the display panel; and H_{screen} stands for a height of the display area of the display panel. In some embodiments, the computer-implemented method includes recognizing a respective selection gesture that matches with one of a plurality of candidate selection gestures; and activating a respective candidate target area from the plurality of candidate target areas to be designated as the target area for the target user. FIG. 8 illustrates a plurality of candidate selection gestures in some embodiments according to the present disclosure.

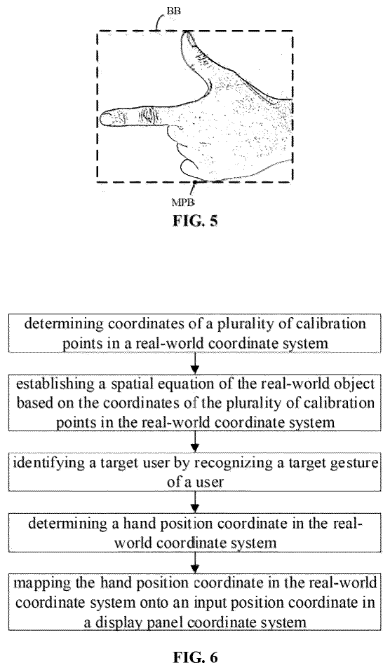

Various appropriate alternative implementations may be practiced in the present disclosure. FIG. 6 is a flow chart illustrating a computer-implemented method in some embodiments according to the present disclosure. In some embodiments, referring to FIG. 6, the computer-implemented method includes determining coordinates of a plurality of calibration points in a world coordinate system. Optionally, the plurality of calibration points are a plurality of points of a real-world object. In one example, the real-world object is a desk, e.g., a desk in a conference room; and the plurality of calibration points are a plurality of corner points of the desk.

In some embodiments, determining the coordinates of the plurality of calibration points in the world coordinate system includes capturing an image of the real-world object using a third camera, for example, a monocular camera attached to the display panel; converting coordinates of the plurality of calibration points in the image of the real-world object in an image coordinate system (e.g., a two-dimensional coordinate system) into the coordinates of the plurality of calibration points in the world coordinate system (e.g., a three-dimensional coordinate system) based on parameters of the third camera. Optionally, the parameters of the third camera include internal parameters and external parameters of the third camera. In one example, the coordinates of the plurality of calibration points in the world coordinate system may be represented as (x1y1, z1), (x2, y2, Z2), (x3, y3, z3), and (x4, y4, z4) for four corner points of the desk.

In some embodiments, the computer-implemented method further includes establishing a spatial equation of the real-world object based on the coordinates of the plurality of calibration points in the world coordinate system. In one example, the spatial equation may be established using any three of the coordinates of the plurality of calibration points in the world coordinate system.

In one example, the spatial equation may be established using (x1, y1, z1), (x2, y2, z2), and (x3, y3, Z3). The spatial equation may be represented as ax+by +cz+d=0,

$$wherein$$

$$a = ( ( y 2 - y 1 ) * ( z 3 - z 1 ) ) - ( ( y 3 - y 1 ) * ( z 2 - z 1 ) ) ; \\ b = ( ( z 2 - z 1 ) * ( x 3 - x 1 ) ) - ( ( z 3 - z 1 ) * ( x 2 - x 1 ) ) ; \\ c = ( ( x 2 - x 1 ) * ( y 3 - y 1 ) ) - ( ( x 3 - x 1 ) * ( y 2 - y 1 ) ) ; \\ and \\ d = ax 1 - by 1 ( c * z 1 ) .$$

In some embodiments, the computer-implemented method further includes identifying a target user, the target user being a user who intends to remotely input information or provide a user command on a display panel. In some embodiments, identifying the target user includes recognizing a target gesture of a user. Optionally, the computer-implemented method further includes comparing the gesture with the target gesture. Upon determination that the gesture is the target gesture, the user is identified as the target user. Examples of target gestures include raising a hand, holding a palm on a table for over a period of time. In one particular example, the target gesture is holding a palm on a table for over 1 second.

In some embodiments, the computer-implemented method further includes determining of a bounding box ofa hand of the target user in a respective image of images of the hand of the target user. FIG. 5 shows a bounding box of a hand of the target user in a respective image of images of the hand of the target user, the computer-implemented method further includes determining a coordinate of a middle point of a bottom side MPB in the image coordinate system; and converting the coordinate of the middle point of the bottom side MPB into a hand position coordinate in the world coordinate system. In one example, the hand position coordinate in the world coordinate system is (x0, y0, z0).

In some embodiments, the computer-implemented method further includes determining a distance between the hand position coordinate in the world coordinate system and a surface of the real-world object (e.g., a surface of the desk). In one example, the distance can be determined according to

$$\frac{\vert ax 0 + by 0 + cz 0 + d \vert}{\sqrt{{a}^{2} + {b}^{2} + {c}^{2}}} .$$

Optionally, a, b, c, and d are parameters of the spatial equation of the real-world object.

In some embodiments, the computer-implemented method further includes determining whether the distance is less than a third threshold distance; upon determination the distance is less than the third threshold distance, determining that the hand of the target user is on the surface of the real-world object (e.g., the surface of the desk); and upon determination that the hand of the target user is on the surface of the real-world object, mapping the hand position coordinate in the world coordinate system onto an input position coordinate in a display panel coordinate system. Various appropriate threshold distances may be used as the third threshold distance, for example, 1 mm, 2 mm, 3 mm, 4 mm, S mm, 6 mm, 7 mm, 8 mm, 9 mm, or 10 mm. In one example, the input position coordinate in the display panel coordinate system (x_{screen}, y_{screen}) can be calculated according to:

$${x}_{screen} = ( x 0 - x 1 ) \times \frac{{w}_{screen}}{( x 2 - x 1 )} ; \\ and \\ {y}_{screen} = ( y 0 - y 1 ) \times \frac{{H}_{screen}}{( y 2 - y 1 )} ;$$

wherein W_{screen} stands for a width of a display area of the display panel; and H_{screen}, stands for a height of the display area of the display panel.

In some embodiments, the input position coordinate in the display panel coordinate system is a coordinate of a cursor in the display panel coordinate system. In some embodiments, the input position coordinate in the display panel coordinate system is a coordinate of a reference point at which displaying of the information inputted by the target user or the user command inputted by the target user starts.

In some embodiments, the computer-implemented method further includes adjusting the input position coordinate by adjusting the hand position coordinate in the world coordinate system. In one example, adjusting the hand position coordinate in the world coordinate system is performed by moving the hand of the target user.

In some embodiments, the computer-implemented method further includes recognizing an initiation gesture indicating an initiation of inputting information or providing the user command. Upon recognizing the initiation gesture, the user is allowed to input information or provide the user command on the display panel. Examples of initiation gestures include a L-shape gesture.

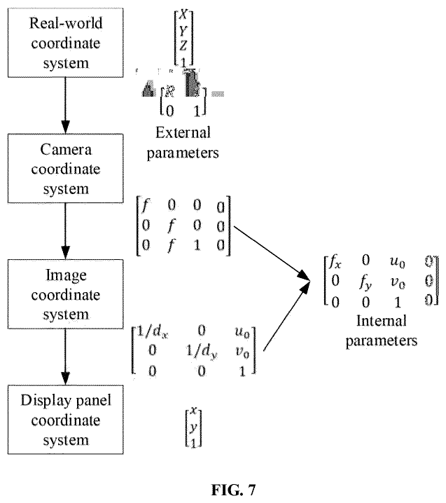

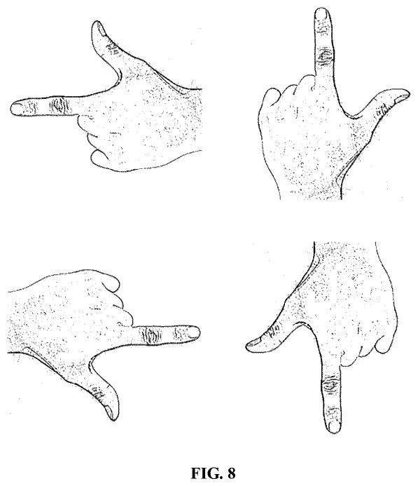

As discussed above, the coordinates of the plurality of calibration points in the image of the real-world object in an image coordinate system may be converted into the coordinates of the plurality of calibration points in the world coordinate system based on internal parameters and external parameters of the third camera. Various appropriate methods may be used for obtaining the internal parameters and the external parameters of the third camera. FIG. 7 illustrates a process of obtaining internal parameters and external parameters of a camera. Referring to FIG. 7, [X, Y, Z, 1] stands for a coordinate in the world coordinate system, [x, y, 1] stands for a coordinate in the display panel coordinate system. The internal parameters are determined by intrinsic parameters of the camera. The internal parameters are expressed in an internal parameter matrix as shown in FIG. 7:

$$[ \begin{matrix}{f}_{x} & 0 & {u}_{0} & 0 \\ 0 & {f}_{y} & {v}_{0} & 0 \\ 0 & 0 & 1 & 0\end{matrix} ] .$$

In the internal parameter matrix

$${f}_{x} = \frac{f}{{d}_{x}} , {f}_{y} = \frac{f}{{d}_{y}} ;$$

wherein f stands for a focal length of the camera, dₓ stands for a width of a photo-sensing pixel along an x-axis of the camara coordinate system, d_{y} stands for a width of the photo-sensing pixel along a y-axis of the camera coordinate system, (u₀, v₀) stand for a coordinate of a central point of a photo-sensing plate in the camera coordinate system.

The external parameters are at least partially determined by relative positions between the world coordinate system and the camera coordinate system. The external parameters are expressed in an external parameter matrix as shown in FIG. 7:

$$[ \begin{matrix}R & t \\ 0 & 1\end{matrix} ] ;$$

wherein R stands for a rotation matrix, T stands for a translation vector.

As used herein, the world coordinate system refers to the user-defined three-dimensional world coordinate system, taking a certain point as the origin and is introduced to describe the position of a target object in the real world. As used herein, the camera coordinate system refers to a coordinate system established with the camera as the origin. It is defined in order to describe the position of the object from the perspective of the camera, as the link between the world coordinate system and the display panel coordinate system. The origin of the camera coordinate system is different from the origin of the world coordinate system.

Various appropriate calibration methods may be used to obtain the internal parameters and the external parameters of the camera. Examples of appropriate calibration methods include Zhengyou Zhang calibration method and checkerboard calibration method.

The computer-implemented method discussed in the present disclosure may use a monocular camera to determine the coordinates of the plurality of calibration points in the world coordinate system, as discussed previously. In alternative embodiments, the computer-implemented method discussed in the present disclosure may use a binocular camera to determine the coordinates of the plurality of calibration points in the world coordinate system. In some embodiments, the computer-implemented method includes determining internal parameters and external parameters of a left eye camera of the binocular camera, and determining internal parameters and external parameters of a right eye camera of the binocular camera. Once the internal parameters and the external parameters of the binocular camera are determined, the computer-implemented method further includes determining coordinates of a plurality of calibration points in a world coordinate system; establishing a spatial equation of the real-world object based on the coordinates of the plurality of calibration points in the world coordinate system; identifying a target user by recognizing a target gesture of a user; determining a hand position coordinate in the world coordinate system; and mapping the hand position coordinate in the world coordinate system onto an input position coordinate in a display panel coordinate system, as discussed in FIG. 6 and associated texts.

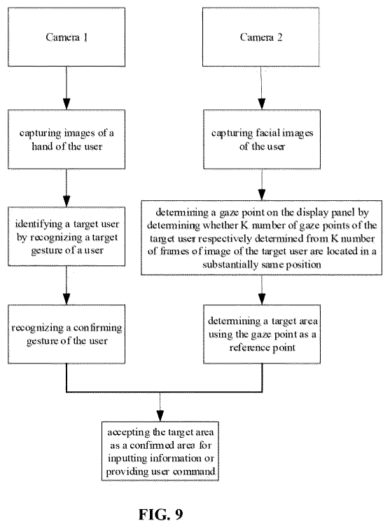

Various appropriate alternative implementations may be practiced in the present disclosure. FIG. 9 is a flow chart illustrating a computer-implemented method in some embodiments according to the present disclosure. Referring to FIG. 9, the computer-implemented method in some embodiments includes capturing images of a hand of the user using one or more cameras (e.g., Camera 1 in FIG. 9), and capturing facial images of the user using one or more cameras (e.g., Camera 2 in FIG. 9). The first camera Camera 1 and the second camera Camera 2 may be attached to the display panel. A respective first image captured by the first camera Camera 1 is divided into a plurality of first sub-areas respectively containing hand images of a plurality of users. A respective second image captured by the second camera Camera 2 is divided into a plurality of second sub-areas respectively containing facial images of the plurality of users. A respective first sub-area out of the plurality of first sub-areas and a respective second sub-area out of the plurality of second sub-areas are identified as containing a hand image and a facial image of a same user, respectively. By obtaining the hand images and the facial images of the plurality of users, a correlation between a hand image and a facial image of a respective user of the plurality of users can be established. Based on the correlation, the respective user can be easily identified when a hand or an object held by a hand is identified as a target object.

In some embodiments the computer-implemented method includes identifying a target user, the target user being a user who intends to remotely input information or provide a user command on a display panel. In some embodiments, identifying the target user includes recognizing a target gesture of a user. Upon determination that a gesture of a user is the target gesture, the user is identified as the target user. Examples of target gestures include raising a hand, holding a palm on a table for over a period of time. In one particular example, the target gesture is holding a palm on a table for over 1 second.

Upon determination of the target user, the computer-implemented method in some embodiments further includes determining a gaze point on the display panel; and determining the target area using the gaze point. Optionally, the computer-implemented method includes determining a gaze direction of the target user, and determining a point on the display panel where the gaze direction intersects with a plane of the display panel, thereby determining the gaze point. Various appropriate methods may be used for determining the gaze direction. In one particular example, the gaze direction is determined using a GazeOnce algorithm.

In some embodiments, the gaze point may be used as a reference point. For example, the target area may be an area having the gaze point as a central point.

In some embodiments, the gaze point may be used as a reference point. In one example, the reference point is a point at which displaying of the information inputted by the target user or the user command inputted by the target user starts. Optionally, the reference point is a point at which displaying a trajectory image starts. Optionally, the reference point is a point at which displaying a stoke of a character (e.g., a Chinese character) or a letter (e.g., a, b, c, d) starts.

In some embodiments, the computer-implemented method in some embodiments further includes determining whether K number of gaze points of the target user respectively determined from K number of frames of image of the target user are located in a substantially same position, K being a positive integer. In one example, K=5. As used herein, the term “substantially same position” refers to that the K number of gaze points are within a circle having a radius less than a threshold value, e.g., less than 10 cm, less than 9 cm, less than 8 cm, less than 7 cm, less than 6 cm, less than 5 cm, less than 4 cm, less than 3 cm, less than 2 cm, or less than 1 cm.

In some embodiments, upon determination the K number of gaze points of the target user respectively determined from K number of frames of image of the target user are located in a substantially same position, the computer-implemented method further includes determining the target area using the gaze point as a reference point. For example, the target area may be an area having the gaze point as a central point. In one particular example, the target area is an area having a size of 50 cm*50 cm, and have the gaze point as its central point.

In some embodiments, the computer-implemented method further includes recognizing a confirming gesture of the user. Upon recognizing the confirming gesture, the computer-implemented method includes accepting the target area as a confirmed area for inputting information or providing user command. In one example, the confirming gesture is an OK gesture.

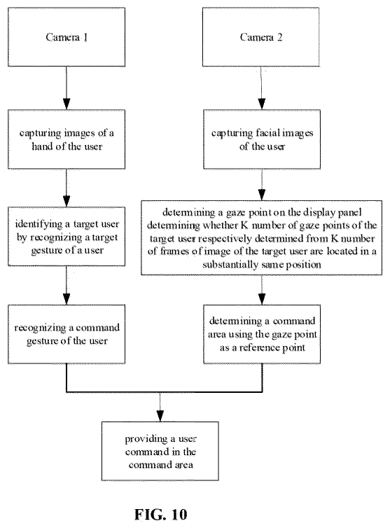

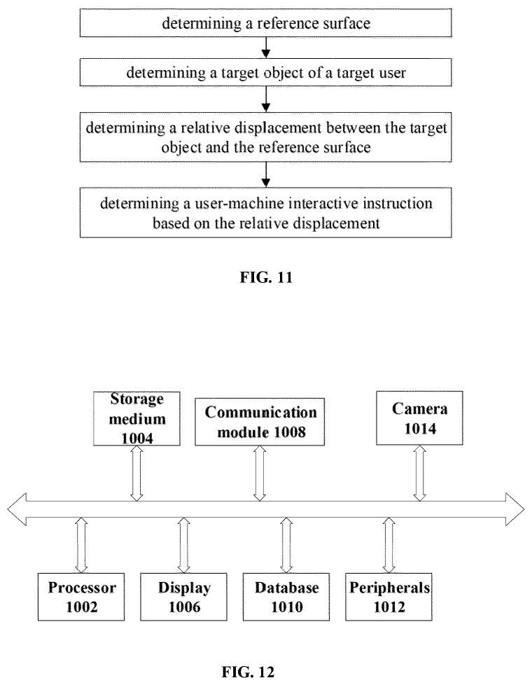

The methods described in the present disclosure may be equally applicable to providing user commands. FIG. 10 is a flow chart illustrating a computer-implemented method in some embodiments according to the present disclosure. Referring to FIG. 10, the computer-implemented method in some embodiments includes capturing images of a hand of the user using one or more cameras (e.g., Camera 1 in FIG. 10), and capturing facial images of the user using one or more cameras (e.g., Camera 2 in FIG. 10). The first camera Camera 1 and the second camera Camera 2 may be attached to the display panel. A respective first image captured by the first camera Camera 1 is divided into a plurality of first sub-areas respectively containing hand images of a plurality of users. A respective second image captured by the second camera Camera 2 is divided into a plurality of second sub-areas respectively containing facial images of the plurality of users. A respective first sub-area out of the plurality of first sub-areas and a respective second sub-area out of the plurality of second sub-areas are identified as containing a hand image and a facial image of a same user, respectively.

In some embodiments the computer-implemented method includes identifying a target user, the target user being a user who intends to remotely input information or provide a user command on a display panel. In some embodiments, identifying the target user includes recognizing a target gesture of a user. Upon determination that a gesture of a user is the target gesture, the user is identified as the target user. Examples of target gestures include raising a hand, holding a palm on a table for over a period of time. In one particular example, the target gesture is holding a palm on a table for over 1 second.

Upon determination of the target user, the computer-implemented method in some embodiments further includes determining a gaze point on the display panel; and determining a command area using the gaze point as a reference point. Optionally, the computer-implemented method includes determining a gaze direction of the target user, and determining a point on the display panel where the gaze direction intersects with a plane of the display panel, thereby determining the gaze point. Various appropriate methods may be used for determining the gaze direction. In one particular example, the gaze direction is determined using a GazeOnce algorithm.

In some embodiments, the computer-implemented method in some embodiments further includes determining whether K number of gaze points of the target user respectively determined from K number of frames of image of the target user are located in a substantially same position, K being a positive integer. In one example, K=S.

In some embodiments, upon determination the K number of gaze points of the target user respectively determined from K number of frames of image of the target user are located in a substantially same position, the computer-implemented method further includes determining the command area using the gaze point as a reference point. For example, the command area may be an area having the gaze point as a central point. In one particular example, the target area is an area having a size of 50 cm*50 cm, and have the gaze point as its central point. Optionally, the computer-implemented method further includes highlighting the command area.

In some embodiments, the computer-implemented method further includes recognizing a command gesture of the user. Upon recognizing the command gesture, the computer-implemented method includes executing a user command based on the command gesture. In one example, a first command gesture is a gesture transitioning from palm to fist, and the computer-implemented method includes executing a first user command of zooming out the command area. In another example, a second command gesture is a gesture transitioning from fist to palm, and the computer-implemented method includes executing a second user command of zooming in the command area. In another example, a third command gesture is lifting and lowering the target user's finger twice relative to the reference surface, and the computer-implemented method includes executing a third user command of double click in the command area.

The inventors of the present disclosure discover a novel and unique method of providing a user-machine interactive instruction. Referring to FIG. 1 to FIG. 10, the computer-implemented method in some embodiments is based on a relative displacement between a target object and a reference surface (e.g., a surface of a desk). FIG. 11 is a flow chart illustrating a computer-implemented method in some embodiments according to the present disclosure. Referring to FIG. 11, the computer-implemented method in some embodiments includes determining a reference surface; determining a target object of a target user, determining a relative displacement between the target object and the reference surface; and determining a user-machine interactive instruction based on the relative displacement. The reference surface may be a surface of any appropriate real-world object. Optionally, the reference surface is a substantially horizontal surface. As used herein, the term “substantially horizontal” encompasses perfectly horizontal surface, and surfaces that generally extend in a horizontal direction, with a tolerance of −20 degrees to 20 degrees (e.g., −20 degrees to −15 degrees. −15 degrees to −10 degrees, −10 degrees to −5 degrees, −5 degrees to 0 degree, 0 degree to 5 degrees, 5 degrees to 10 degrees, 10 degrees to 15 degrees, or 15 degrees to 20 degrees). In one example, the reference surface is a surface of a desk, e.g., a surface of a desk in a conference room.

In some embodiments, determining the reference surface includes determining coordinates of a plurality of calibration points in a three-dimensional coordinate system (e.g., a world coordinate system or a camera coordinate system); and deriving the reference surface based on the plurality of calibration points. In some embodiments, determining the coordinates of the plurality of calibration points in the three-dimensional coordinate system includes capturing an image of the real-world object using a third camera, for example, a monocular camera attached to the display panel; converting coordinates of the plurality of calibration points in the image of the real-world object in an image coordinate system (e.g., a two-dimensional coordinate system) into the coordinates of the plurality of calibration points in the three-dimensional coordinate system (e.g., a three-dimensional coordinate system) based on parameters of the third camera. Optionally, the parameters of the third camera include internal parameters and external parameters of the third camera. In one example, the coordinates of the plurality of calibration points in the three-dimensional coordinate system may be represented as (x1, y1, z1), (x2, y2, z2), (x3, y3, t3), and (x4, y4, z4) for four corner points of the desk. In another example, the reference surface is a surface having (x1, y1, z1), (x2, y2, z2), (x3, y3, z3), and (x4, y4, z4) as four corner points.

In some embodiments, the computer-implemented method further includes identifying a user who intends to remotely provide the user-machine interactive instruction on a display panel as the target user.

In some embodiments, the computer-implemented method further includes identifying an object making an object motion trajectory as the target object.

In some embodiments, determining the user-machine interactive instruction based on the relative displacement includes displaying a trajectory image in a target area based on the object motion trajectory of the user relative to the reference surface. In some embodiments, determining the user-machine interactive instruction based on the relative displacement includes executing a user command based on the object motion trajectory of the user relative to the reference surface.

In some embodiments, the user-machine interactive instruction comprises displaying a trajectory image. In some embodiments, the computer-implemented method further includes detecting and tracking the object motion trajectory relative to the reference surface; displaying the trajectory image in a target area based on the object motion trajectory of the user relative to the reference surface; determining whether the object motion trajectory of the user transitions into a pausing gesture; and upon determination the object motion trajectory of the user transitions into a pausing gesture, pausing displaying the trajectory image. Optionally, the pausing gesture is a gesture in which the target object moves toward a pausing direction relative to the reference surface. Optionally, a gesture is recognized as the pausing gesture if the object making the object motion trajectory moves along the pausing direction relative to the reference surface by a distance exceeding a second threshold distance.

In some embodiments, the user-machine interactive instruction comprises displaying a trajectory image. In some embodiments, the computer-implemented method further includes determining whether the object motion trajectory of the user transitions into a displaying gesture; and upon determination the object motion trajectory of the user transitions into a displaying gesture, displaying the trajectory image in a target area based on the object motion trajectory of the user relative to the reference surface. In one example, upon determination the object motion trajectory of the user transitions into the displaying gesture, the display panel begins displaying a stroke of a character or a letter or a diagram based on the object motion trajectory of the user relative to the reference surface. In another example, the displaying gesture is detected subsequent to the detection of the pausing gesture. Upon determination that the displaying gesture is detected subsequent to the detection of the pausing gesture, the display panel resumes displaying a new stroke of a character or a letter or a diagram based on the object motion trajectory of the user relative to the reference surface. Optionally, the displaying gesture is a gesture contacting a finger of the target user with the reference surface.

Upon determination that the displaying gesture is not detected, the computer-implemented method includes continuing pausing the detecting and tracking the object motion trajectory of the user; and pausing obtaining data of the object motion trajectory.

In some embodiments, when the displaying gesture is not detected, the computer-implemented method continues detecting and tracking the object motion trajectory relative to the reference surface, without converting, in real time, the object motion trajectory relative to the reference surface into the trajectory image. Although converting the object motion trajectory relative to the reference surface into the trajectory image is discontinued, the computer-implemented method continues detecting and tracking the object motion trajectory relative to the reference surface. By continuing detecting and tracking the object motion trajectory relative to the reference surface, once a displaying gesture is detected, the computer-implemented method resumes converting, in real time, the object motion trajectory relative to the reference surface into the trajectory image. When converting, in real time, the object motion trajectory relative to the reference surface into the trajectory image is resumed, a reference point at which displaying the trajectory image starts is required. The inventors of the present disclosure discover that, by continuing detecting and tracking the object motion trajectory relative to the reference surface while the converting, in real time, the object motion trajectory relative to the reference surface into the trajectory image is paused, a new trajectory image (e.g., a trajectory image of a new stroke of a character or a letter) can be accurately displayed at an appropriate position relative to a previous trajectory image (e.g., a trajectory image of a previous stroke of a character or a letter).

The process described above can be repeated until all strokes are complete. The combination of trajectory images of all strokes results in a combined image of a character or a letter, a sentence, or a paragraph, etc, in which all strokes are arranged in appropriate positions. An image of a legible text can be obtained.

In some embodiments, the user-machine interactive instruction comprises recognizing an initiation gesture. In some embodiments, the computer-implemented method further includes recognizing an initiation gesture indicating an initiation of providing the user-machine interactive instruction. Optionally, providing the user-machine interactive instruction is performed subsequent to recognizing the initiation gesture.

In some embodiments, the user-machine interactive instruction comprises executing a user command, in some embodiments, the computer-implemented method further includes detecting and tracking the object motion trajectory of the user; and executing the user command based on the object motion trajectory of the user relative to the reference surface.

In some embodiments, the user-machine interactive instruction comprises adjusting a reference point (e.g., a reference point at which displaying of the trajectory image starts). Optionally, adjusting the reference point comprises recognizing an adjusting gesture of the target user. Optionally, the adjusting gesture is a gesture having a target object (e.g., a finger) of the target user not in contact with the reference surface, and moving along an adjusting direction. Optionally, the computer-implemented method further comprises adjusting the reference point along the adjusting direction of a movement of the target object (e.g., a finger movement). Optionally, the gesture is recognized as the adjusting gesture when the movement of the target object (e.g., the finger movement) is within a distance with respect to the reference surface less than a first threshold distance. In one particular example, the adjusting gesture is a gesture in which the target object (e.g., the finger) moves less than 5 cm on a plane parallel to the reference surface.

In some embodiments, the computer-implemented method further includes determining a target area on the display panel designated for the target user to provide the user-machine interactive instruction.

In another aspect, the present disclosure provides a user input system. In some embodiments, the user input system includes one or more cameras; a display panel; a memory; and one or more processors. In some embodiments, the memory and the one or more processors are connected with each other; and the memory stores computer-executable instructions for controlling the one or more processors to determine a reference surface; determine a target object of a target user, determine a relative displacement between the target object and the reference surface; and determine a user-machine interactive instruction based on the relative displacement.

FIG. 12 is a schematic diagram illustrating a user input system in some embodiments according to the present disclosure. FIG. 12 shows a user input system for implementing the method according to the present disclosure. Referring to FIG. 12, the user input system 1000 may include any appropriate type of interactive white board, such as a plasma interactive white board, a liquid crystal display (LCD) interactive white board, a touch screen interactive white board, a projection interactive white board, a non-smart interactive white board, a smart interactive white board, etc. The user input system 1000 may also include other computing systems, such as a personal computer (PC), a tablet or mobile computer, or a smart phone, etc. In addition, the user input system 1000 may be any appropriate content-presentation device capable of presenting any appropriate content. Users may interact with the user input system 1000 to perform other activities of interest.

As shown in FIG. 12, the user input system 1000 may include a processor 1002, a storage medium 1004, a display 1006, a communication module 1008, a database 1010, peripherals 1012, and a camera 1014. Certain devices may be omitted, and other devices may be included to better describe the relevant embodiments.

The processor 1002 may include any appropriate processor or processors. Further, the processor 1002 may include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 1012 may include various sensors and other I/O devices, such as keyboard and mouse.

In some embodiments, the memory further stores computer-executable instructions for controlling the one or more processors to determine coordinates of a plurality of calibration points in a three-dimensional coordinate system (e.g., a world coordinate system); and derive the reference surface based on the plurality of calibration points, thereby determining the reference surface.

In some embodiments, the memory further stores computer-executable instructions for controlling the one or more processors to capture an image of a real-world object using a camera; and convert coordinates of the plurality of calibration points in the image of the real-world object in an image coordinate system into the coordinates of the plurality of calibration points in the three-dimensional coordinate system based on parameters of the camera, thereby determining the coordinates of the plurality of calibration points in the three-dimensional coordinate system.

In some embodiments, the memory further stores computer-executable instructions for controlling the one or more processors to identify a user who intends to remotely provide the user-machine interactive instruction on a display panel as the target user.

In some embodiments, the memory further stores computer-executable instructions for controlling the one or more processors to identify an object making an object motion trajectory as the target object.

In some embodiments, the user-machine interactive instruction comprises displaying a trajectory image. In some embodiments, the memory further stores computer-executable instructions for controlling the one or more processors to detect and track the object motion trajectory of the user; display the trajectory image in a target area based on the object motion trajectory of the user relative to the reference surface; determine whether the object motion trajectory of the user transitions into a pausing gesture; and upon determination the object motion trajectory of the user transitions into a pausing gesture, pause displaying the trajectory image. Optionally, the pausing gesture is a gesture in which the target object moves toward a pausing direction relative to the reference surface. Optionally, a gesture is recognized as the pausing gesture if the object making the object motion trajectory moves along the pausing direction relative to the reference surface by a distance exceeding a second threshold distance. In one example, the pausing direction is an upward vertical direction. Optionally, a gesture is recognized as the pausing gesture if the object making the object motion trajectory moves along the upward vertical direction by a distance exceeding a second threshold distance

In some embodiments, the user-machine interactive instruction comprises displaying a trajectory image. In some embodiments, the memory further stores computer-executable instructions for controlling the one or more processors to determine whether the object motion trajectory of the user transitions into a displaying gesture; and upon determination the object motion trajectory of the user transitions into a displaying gesture, display the trajectory image in a target area based on the object motion trajectory of the user relative to the reference surface. Optionally, the displaying gesture is a gesture contacting a finger of the target user with the reference surface.

In some embodiments, the user-machine interactive instruction comprises recognizing an initiation gesture. In some embodiments, the memory further stores computer-executable instructions for controlling the one or more processors to recognize the initiation gesture indicating an initiation of providing the user-machine interactive instruction. Optionally, providing the user-machine interactive instruction is performed subsequent to recognizing the initiation gesture.

In some embodiments, the user-machine interactive instruction comprises executing a user command. In some embodiments, the memory further stores computer-executable instructions for controlling the one or more processors to detect and track the object motion trajectory of the user relative to the reference surface; and execute the user command based on the object motion trajectory of the user relative to the reference surface.

In some embodiments, the memory further stores computer-executable instructions for controlling the one or more processors to identify a target user, the target user being a user who intends to remotely input information or provide a user command on a display panel; and determine a target area on the display panel designated for the target user to input information or provide the user command. The display panel is configured to display a trajectory image in the target area or executing a user command based on an object motion trajectory of the user relative to the reference surface.

In some embodiments, the memory further stores computer-executable instructions for controlling the one or more processors to determine a gaze point on the display panel; and determine the target area using the gaze point. Optionally, the reference point is a point at which displaying of the information inputted by the target user or the user command inputted by the target user starts.

In some embodiments, the user-machine interactive instruction comprises adjusting a reference point (e.g., a reference point at which displaying the trajectory image starts). Optionally, the memory further stores computer-executable instructions for controlling the one or more processors to recognize an adjusting gesture of the target user.

In some embodiments, the adjusting gesture is a gesture having a target object (e.g., a finger) of the target user not in contact with a surface of a desk, and moving along an adjusting direction. In some embodiments, the memory further stores computer-executable instructions for controlling the one or more processors to adjust the reference point along the adjusting direction of a movement of the target object (e.g., a finger movement). Optionally, the gesture is recognized as the adjusting gesture when the movement of the target object (e.g., the finger movement) is within a distance with respect to the reference surface less than a first threshold distance.

In some embodiments, the memory further stores computer-executable instructions for controlling the one or more processors to determine whether K number of gaze points of the target user respectively determined from K number of frames of image of the target user are located in a substantially same position.

In some embodiments, the memory further stores computer-executable instructions for controlling the one or more processors to determine coordinates of a plurality of calibration points in a three-dimensional coordinate system (e.g., a world coordinate system or a camera coordinate system); establish a spatial equation of the real-world object based on the coordinates of the plurality of calibration points in the three-dimensional coordinate system; determine a position coordinate of the target object in the three-dimensional coordinate system; and map the position coordinate of the target object in the three-dimensional coordinate system onto an input position coordinate in a display panel coordinate system, thereby determining the target area.

In some embodiments, the display panel is virtually divided into a plurality of candidate target areas, in some embodiments, the memory further stores computer-executable instructions for controlling the one or more processors to designate at least one candidate target area of the plurality of candidate target areas as the target area for the target user.

In some embodiments, the memory further stores computer-executable instructions for controlling the one or more processors to activate the target area. Optionally, the memory further stores computer-executable instructions for controlling the one or more processors to recognize a respective selection gesture that matches with one of a plurality of candidate selection gestures; and activate a respective candidate target area from the plurality of candidate target areas to be designated as the target area for the target user.

In some embodiments, the memory further stores computer-executable instructions for controlling the one or more processors to detect and tracking the object motion trajectory of the user; determine whether the object motion trajectory of the user transitions into a pausing gesture; and upon determination the object motion trajectory of the user transitions into a pausing gesture, pause displaying the trajectory image.

In some embodiments, the memory further stores computer-executable instructions for controlling the one or more processors to convert, in real time, the object motion trajectory relative to the reference surface into the trajectory image; pause convening the object motion trajectory relative to the reference surface into the trajectory image upon detecting a pausing gesture; and continue detecting and tracking the object motion trajectory relative to the reference surface subsequent to pausing converting the object motion trajectory relative to the reference surface into the trajectory image.

In some embodiments, the pausing gesture is a gesture in which the target object moves toward a pausing direction relative to the reference surface. Optionally, a gesture is recognized as the pausing gesture if the object making the object motion trajectory of the user moves along the pausing direction by a distance exceeding a second threshold distance.

In some embodiments, the user-machine interactive instruction comprises recognizing an initiation gesture. In some embodiments, the memory further stores computer-executable instructions for controlling the one or more processors to recognize the initiation gesture indicating an initiation of inputting information or providing the user command. Optionally, displaying the trajectory image in the target area or executing the user command is performed subsequent to recognizing the initiation gesture.

In some embodiments, the user-machine interactive instruction further comprises adjusting the target area to obtain an adjusted target area. Optionally, the target object includes a palm of the target user, and the target area is adjusted in response to adjusting a position of a palm of the user.

In some embodiments, the memory further stores computer-executable instructions for controlling the one or more processors to determine whether the adjusted target area overlaps with any of activated target areas in the display panel. Optionally, upon determination the adjusted target area overlaps with any of activated target areas in the display panel, the memory further stores computer-executable instructions for controlling the one or more processors to cause the display panel to provide a notification to the user that the adjusted target area overlaps with any of activated target areas in the display panel. Optionally, upon determination the adjusted target area does not overlap with any of activated target areas in the display panel, the memory further stores computer-executable instructions for controlling the one or more processors to replace the target area with the adjusted target area for inputting information or providing user command.

In some embodiments, the memory further stores computer-executable instructions for controlling the one or more processors to recognize a confirming gesture of the user; and upon recognizing the confirming gesture, accept the adjusted target area when the target area is subject to adjustment or the target area when the target area is not subject to adjustment as a confirmed area for inputting information or providing user command.

In some embodiments, the memory further stores computer-executable instructions for controlling the one or more processors to detect and tracking a gesture of the user; and compare the gesture of the user with a target gesture. Optionally, upon determination that the gesture of the user is the target gesture, the user is identified as the target user.

In another aspect, the present disclosure provides a computer-program product comprising a non-transitory tangible computer-readable medium having computer-readable instructions thereon. In some embodiments, the computer-readable instructions are executable by one or more processors to cause the one or more processors to perform determining a reference surface; determining a target object of a target user; determining a relative displacement between the target object and the reference surface; and determining a user-machine interactive instruction based on the relative displacement.

In some embodiments, the computer-readable instructions are executable by one or more processors to cause the one or more processors to further perform determining coordinates of a plurality of calibration points in a three-dimensional coordinate system (e.g., a world coordinate system or a camera coordinate system); and deriving the reference surface based on the plurality of calibration points, thereby determining the reference surface.

In some embodiments, the computer-readable instructions are executable by one or more processors to cause the one or more processors to further perform capturing an image of a real-world object using a camera; and convening coordinates of the plurality of calibration points in the image of the real-world object in an image coordinate system into the coordinates of the plurality of calibration points in the three-dimensional coordinate system based on parameters of the camera, thereby determining the coordinates of the plurality of calibration points in the three-dimensional coordinate system.

In some embodiments, the computer-readable instructions are executable by one or more processors to cause the one or more processors to further perform identifying a user who intends to remotely provide the user-machine interactive instruction on a display panel as the target user.

In some embodiments, the computer-readable instructions are executable by one or more processors to cause the one or more processors to further perform identifying an object making an object motion trajectory as the target object.

In some embodiments, the user-machine interactive instruction comprises displaying a trajectory image. In some embodiments, the computer-readable instructions are executable by one or more processors to cause the one or more processors to further perform detecting and tracking the object motion trajectory of the user; displaying the trajectory image in a target area based on the object motion trajectory of the user relative to the reference surface; determining whether the object motion trajectory of the user transitions into a pausing gesture; and upon determination the object motion trajectory of the user transitions into a pausing gesture, pausing displaying the trajectory image. Optionally, the pausing gesture is a gesture in which the target object moves toward a pausing direction relative to the reference surface. Optionally, a gesture is recognized as the pausing gesture if the object making the object motion trajectory moves along the pausing direction relative to the reference surface by a distance exceeding a second threshold distance.

In some embodiments, the user-machine interactive instruction comprises displaying a trajectory image. In some embodiments, the computer-readable instructions are executable by one or more processors to cause the one or more processors to further perform determining whether the object motion trajectory of the user transitions into a displaying gesture; and upon determination the object motion trajectory of the user transitions into a displaying gesture, displaying the trajectory image in a target area based on the object motion trajectory of the user relative to the reference surface. Optionally, the displaying gesture is a gesture contacting a finger of the target user with the reference surface.

In some embodiments, the user-machine interactive instruction comprises recognizing an initiation gesture. In some embodiments, the computer-readable instructions are executable by one or more processors to cause the one or more processors to further perform recognizing the initiation gesture indicating an initiation of providing the user-machine interactive instruction. Optionally, providing the user-machine interactive instruction is performed subsequent to recognizing the initiation gesture.

In some embodiments, the user-machine interactive instruction comprises executing a user command. In some embodiments, the computer-readable instructions are executable by one or more processors to cause the one or more processors to further perform detecting and tracking the object motion trajectory of the user; and executing the user command based on the object motion trajectory of the user relative to the reference surface.

In some embodiments, the computer-readable instructions are executable by one or more processors to cause the one or more processors to further perform determining a gaze point on the display panel; and determining the target area using the gaze point. Optionally, the reference point is a point at which displaying of the information inputted by the target user or the user command inputted by the target user starts.

In some embodiments, the user-machine interactive instruction comprises adjusting a reference point. In some embodiments, the computer-readable instructions are executable by one or more processors to cause the one or more processors to further perform adjusting the reference point. Optionally, the computer-readable instructions are executable by one or more processors to cause the one or more processors to further perform recognizing an adjusting gesture of the target user.

In some embodiments, the adjusting gesture is a gesture having a target object (e.g., a finger) of the target user not in contact with a surface of a desk, and moving along an adjusting direction. In some embodiments, the computer-readable instructions are executable by one or more processors to cause the one or more processors to further perform adjusting the reference point along the adjusting direction of a movement of the target object (e.g., a finger movement). Optionally, the gesture is recognized as the adjusting gesture when the movement of the target object (e.g., the finger movement) is within a distance with respect to the reference surface less than a first threshold distance. In one particular example, the adjusting gesture is a gesture in which the target object (e.g., the finger) moves less than 5 cm on a plane parallel to the reference surface.

In some embodiments, the computer-readable instructions are executable by one or more processors to cause the one or more processors to further perform determining whether K number of gaze points of the target user respectively determined from K number of frames of image of the target user are located in a substantially same position.

In some embodiments, the computer-readable instructions are executable by one or more processors to cause the one or more processors to further perform determining coordinates of a plurality of calibration points in a three-dimensional coordinate system (e.g., a world coordinate system or a camera coordinate system); establishing a spatial equation of the real-world object based on the coordinates of the plurality of calibration points in the three-dimensional coordinate system; determining a position coordinate of the target object in the three-dimensional coordinate system; and mapping the position coordinate of the target object in the three-dimensional coordinate system onto an input position coordinate in a display panel coordinate system, thereby determining the target area.

In some embodiments, the computer-readable instructions are executable by one or more processors to cause the one or more processors to further perform virtually dividing the display panel into a plurality of candidate target areas. In some embodiments, the computer-readable instructions are executable by one or more processors to cause the one or more processors to further perform designating at least one candidate target area of the plurality of candidate target areas as the target area for the target user.

In some embodiments, the computer-readable instructions are executable by one or more processors to cause the one or more processors to further perform activating the target area. In some embodiments, the computer-readable instructions are executable by one or more processors to cause the one or more processors to further perform recognizing a respective selection gesture that matches with one of a plurality of candidate selection gestures; and activating a respective candidate target area from the plurality of candidate target areas to be designated as the target area for the target user.

In some embodiments, the computer-readable instructions are executable by one or more processors to cause the one or more processors to further perform detecting and tracking the object motion trajectory of the user; determining whether the object motion trajectory of the user transitions into a pausing gesture; and upon determination the object motion trajectory of the user transitions into a pausing gesture, pausing displaying the trajectory image.

In some embodiments, the computer-readable instructions are executable by one or more processors to cause the one or more processors to further perform converting, in real time, the object motion trajectory relative to the reference surface into the trajectory image; pausing converting the object motion trajectory relative to the reference surface into the trajectory image upon detecting a pausing gesture; and continuing detecting and tracking the object motion trajectory relative to the reference surface subsequent to pausing converting the object motion trajectory relative to the reference surface into the trajectory image.

In some embodiments, the pausing gesture is a gesture in which the target object moves toward a pausing direction relative to the reference surface. Optionally, a gesture is recognized as the pausing gesture if the object making the object motion trajectory moves along the pausing direction by a distance exceeding a second threshold distance.

In some embodiments, the user-machine interactive instruction comprises recognizing an initiation gesture. In some embodiments, the computer-readable instructions are executable by one or more processors to cause the one or more processors to further perform recognizing the initiation gesture indicating an initiation of inputting information or providing the user command. Optionally, displaying the trajectory image in the target area or executing the user command is performed subsequent to recognizing the initiation gesture.

In some embodiments, the user-machine interactive instruction further comprises adjusting the target area. In some embodiments, the computer-readable instructions are executable by one or more processors to cause the one or more processors to further perform adjusting the target area to obtain an adjusted target area. Optionally, the target object comprises a palm of the target user, and adjusting the target area is performed in response to adjusting a position of the palm of the user.

In some embodiments, the computer-readable instructions are executable by one or more processors to cause the one or more processors to further perform determining whether the adjusted target area overlaps with any of activated target areas in the display panel.

In some embodiments, the computer-readable instructions are executable by one or more processors to cause the one or more processors to further perform, upon determination the adjusted target area overlaps with any of activated target areas in the display panel, providing a notification to the user that the adjusted target area overlaps with any of activated target areas in the display panel.

In some embodiments, the computer-readable instructions are executable by one or more processors to cause the one or more processors to further perform, upon determination the adjusted target area does not overlap with any of activated target areas in the display panel, replacing the target area with the adjusted target area for inputting information or providing user command.

In some embodiments, the computer-readable instructions are executable by one or more processors to cause the one or more processors to further perform recognizing a confirming gesture of the user; and upon recognizing the confirming gesture, accepting the adjusted target area as a confirmed area for inputting information or providing user command when the target area is subject to adjustment, or accepting the target area as the confirmed area for inputting information or providing user command when the target area is not subject to adjustment.

In some embodiments, the computer-readable instructions are executable by one or more processors to cause the one or more processors to further perform detecting and tracking a gesture of the user; and comparing the gesture of the user with a target gesture. Optionally, upon determination that the gesture of the user is the target gesture, the user is identified as the target user.

All or some of steps of the method, functional modules/units in the system and the device disclosed above may be implemented as software, firmware, hardware, or suitable combinations thereof. In a hardware implementation, a division among functional modules/units mentioned in the above description does not necessarily correspond to the division among physical components. For example, one physical component may have a plurality of functions, or one function or step may be performed by several physical components in cooperation. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable storage medium, which may include a computer storage medium (or a non-transitory medium) and a communication medium (or a transitory medium). The term computer storage medium includes volatile and nonvolatile, removable and non-removable media implemented in any method or technology for storage of information, such as computer readable instructions, data structures, program modules or other data, as is well known to one of ordinary skill in the art. A computer storage medium includes, but is not limited to, RAM, ROM, EEPROM, flash memory or other memory technology, CD-ROM, Digital Versatile Disk (DVD) or other optical disk storage, magnetic cassette, magnetic tape, magnetic disk storage or other magnetic storage device, or any other medium which may be used to store desired information, and which may be accessed by a computer. In addition, a communication medium typically embodies computer readable instructions, data structures, program modules or other data in a modulated data signal such as a carrier wave or other transport mechanism, and includes any information delivery medium, as is well known to one of ordinary skill in the art.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A computer-implemented method, comprising:
determining a reference surface;
determining a target object of a target user;
determining a relative displacement between the target object and the reference surface; and
determining a user-machine interactive instruction based on the relative displacement.

2. The computer-implemented method of claim 1, wherein determining the reference surface comprises:
determining coordinates of a plurality of calibration points in a three-dimensional coordinate system; and
deriving the reference surface based on the plurality of calibration points.

3. The computer-implemented method of claim 2, wherein determining the coordinates of the plurality of calibration points in the three-dimensional coordinate system comprises:
capturing an image of a real-world object using a camera; and
converting coordinates of the plurality of calibration points in the image of the real-world object in an image coordinate system into the coordinates of the plurality of calibration points in the three-dimensional coordinate system based on parameters of the camera.

4. The computer-implemented method of claim 1, wherein the user-machine interactive instruction comprises displaying a trajectory image;
wherein the computer-implemented method further comprises:
detecting and tracking an object motion trajectory of the target object relative to the reference surface; and
displaying the trajectory image in a target area based on the object motion trajectory of the user relative to the reference surface.

5. The computer-implemented method of claim 4, further comprising:
determining whether the object motion trajectory of the user transitions into a pausing gesture; and
upon determination the object motion trajectory of the user transitions into a pausing gesture, pausing displaying the trajectory image.

6. The computer-implemented method of claim 4, further comprising:
converting, in real time, the object motion trajectory relative to the reference surface into the trajectory image;
pausing converting the object motion trajectory relative to the reference surface into the trajectory image upon detecting a pausing gesture; and
continuing detecting and tracking the object motion trajectory of the target object relative to the reference surface subsequent to pausing converting the object motion trajectory relative to the reference surface into the trajectory image.

7. The computer-implemented method of claim 6, further comprising resuming converting, in real time, the object motion trajectory relative to the reference surface into a new trajectory image at a new reference point at which the new trajectory image starts relative to a previous trajectory image;
wherein the new reference point is determined based on a result of continuing detecting and tracking the object motion trajectory relative to the reference surface.

8. The computer-implemented method of claim 5, wherein the pausing gesture is a gesture in which the target object moves toward a pausing direction relative to the reference surface; and
a gesture is recognized as the pausing gesture if the object making the object motion trajectory of the user moves along the pausing direction relative to the reference surface by a distance exceeding a second threshold distance.

9. The computer-implemented method of claim 4, wherein the computer-implemented method further comprises:
determining whether the object motion trajectory of the user transitions into a displaying gesture; and
upon determination the object motion trajectory of the user transitions into a displaying gesture, displaying the trajectory image in a target area based on the object motion trajectory of the user relative to the reference surface.

10. The computer-implemented method of claim 9, wherein the displaying gesture is a gesture contacting a finger of the target user with the reference surface.

11. The computer-implemented method of claim 1, further comprising recognizing an initiation gesture indicating an initiation of providing the user-machine interactive instruction;
wherein providing the user-machine interactive instruction is performed subsequent to recognizing the initiation gesture.

12. The computer-implemented method of claim 1, wherein the user-machine interactive instruction comprises executing a user command;
wherein the computer-implemented method further comprises:
detecting and tracking the object motion trajectory of the target object relative to the reference surface; and
executing the user command based on the object motion trajectory relative to the reference surface.

13. The computer-implemented method of claim 1, wherein the user-machine interactive instruction comprises adjusting a reference point;
wherein adjusting the reference point comprises recognizing an adjusting gesture of the target user.

14. The computer-implemented method of claim 13, wherein the adjusting gesture is a gesture having the target object of the target user not in contact with the reference surface, and moving along an adjusting direction;
wherein the computer-implemented method further comprises adjusting the reference point along the adjusting direction of a movement of the target object;
wherein the gesture is recognized as the adjusting gesture when the movement of the target object is within a distance with respect to the reference surface less than a first threshold distance.

15. The computer-implemented method of claim 13, wherein the reference point is a point at which displaying a trajectory image starts.

16. The computer-implemented method of claim 1, further comprising determining a target area on the display panel designated for the target user to provide the user-machine interactive instruction.

17. The computer-implemented method of claim 16, wherein the user-machine interactive instruction comprises displaying a trajectory image in the target area;
wherein determining the target area comprises:
determining a gaze point on the display panel; and
determining the target area using the gaze point.

18. The computer-implemented method of claim 17, wherein
determining the gaze point comprises determining whether K number of gaze points of the target user respectively determined from K number of frames of image of the target user are located in a substantially same position.

19. (canceled)

20. (canceled)

21. (canceled)

22. (canceled)

23. (canceled)

24. (canceled)

25. (canceled)

26. (canceled)

27. (canceled)

28. (canceled)

29. A user input system, comprising:
one or more cameras;
a display panel;
a memory; and
one or more processors;
wherein the memory and the one or more processors are connected with each other; and
the memory stores computer-executable instructions for controlling the one or more processors to:
determine a reference surface;
determine a target object of a target user;
determine a relative displacement between the target object and the reference surface; and
determine a user-machine interactive instruction based on the relative displacement.

30. A computer-program product, comprising a non-transitory tangible computer-readable medium having computer-readable instructions thereon, the computer-readable instructions being executable by a processor to cause the processor to perform:
determining a reference surface;
determining a target object of a target user;
determining a relative displacement between the target object and the reference surface; and
determining a user-machine interactive instruction based on the relative displacement.
